(19) United States
(12) Patent Application Publication
(10) Pub. No.: US 2008/0240010 A1
(43) Pub. Date: Oct. 2, 2008

(54) INTELLIGENT ORCHESTRATION OF CROSS-MEDIA COMMUNICATIONS

(75) Inventors: VENUGOPAL VASUDEVAN, PALATINE, IL (US); TZVETAN T. HOROZOV, HOFFMAN ESTATES, IL (US); FRANCIS P. JATICO, CHICAGO, IL (US); NITYA NARASIMHAN, LAKE ZURICH, IL (US); DANIEL F. STEWART, HOFFMAN ESTATES, IL (US); JOSEPH F. WODKA, HOFFMAN ESTATES, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/691,285

(22) Filed: Mar. 26, 2007

(51) Int. Cl. H04L 12/56

(52) U.S. Cl. 370/312

(57) ABSTRACT

A method and architecture for managing a communication campaign direct toward a plurality of media consumption devices associated with a common user (101), including obtaining communication addresses for each of the plurality of media consumption devices (110, 116, 122) associated with the common user, associating the common user with a communication campaign, and prompting transmission of communications to the common user via the plurality of media consumption devices based on a campaign policy.

The present disclosure relates generally to communications technology and more specifically to managing a communication campaigns directed to multiple different communication devices associated with a common user.

### BACKGROUND

The relatively recent proliferation of communications technologies has enabled users to communicate over different communication media using a variety of different devices, wherein each device has a corresponding communication address. Users commonly communicate voice and data using wireless communication handsets connected to cellular telephony networks and personal computers connected to the Internet among other networks. Users may also communicate interactively with content providers, for example, with cable or satellite service providers using set-top boxes (STBs) having interactive Electronic Program Guides (EPGs) from which content may be browsed and selected for consumption according to a broadcast schedule or “on-demand”. In some instances, there is a need to manage communications based on the intended recipient rather than on the particular device or medium through which the communication occurs.

The various aspects, features and advantages of the disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 illustrates a system of communication networks and a communication campaign management entity.

FIG. 2 is a process diagram for managing a communication campaign.

FIG. 3 communication campaign management architecture.

### DETAILED DESCRIPTION

According to one aspect of the disclosure, a communication campaign is directed toward a particular user via a plurality of communication devices associated with the user. In one embodiment, the communication campaign is a media campaign wherein the communication devices are media consumption devices in the sense that they receive and present media on a user interface associated with device, for example, at an audio and/or video interface thereof. In some embodiments, the media consumption devices also have the ability to transmit outgoing communications, for example, to request media or to communicate with other entities, as discussed further below. The communication devices associated with each user are generally different, though in some embodiments a user may have more than one device of the same type, for example, more than one cell phone. Each communication device generally has a unique communication address, although more than one user may be associated with a particular address, as discussed more fully below.

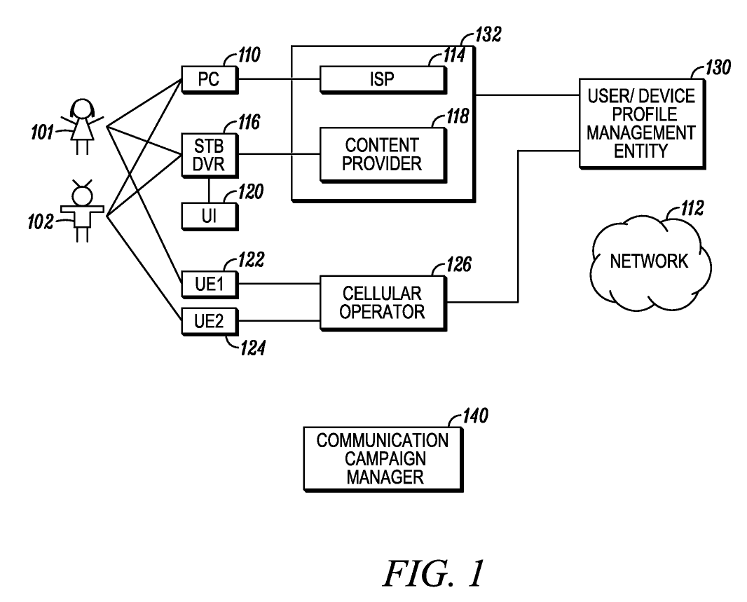

In FIG. 1, users 101 and 102 each have associated therewith a plurality of different communication devices, wherein each of the communication devices has a corresponding communication address. The users 101 and 102 share a personal computer (PC) 110 communicably coupled to a network, like the Internet 112, by a network service provider 114. The exemplary PC 110 has a communication address, like a unique Internet Protocol (IP) address, which is generally dependent on the type of network to which the PC is connected. The users 101 and 102 also share a set-top box/digital video recorder (STB/DVR) device 116 communicably coupled to a provider 118 of content for consumption on an associated user interface 120, like a television monitor. The STB/DVR also has a unique communication address assigned by the content service provider. The users 101 and 102 each have an associated mobile subscriber device 122 and 124, respectively, communicably coupled to a cellular subscriber network 126, which may be communicably coupled to the Internet or to another data network, usually by a gateway entity. The mobile devices 122 and 124 have corresponding communication addresses, for example, an International Mobile Subscriber Identity (IMSI) number of the type assigned to GSM and UMTS terminals.

In FIG. 1, user and device profile information is stored and managed by a profile management entity 130. The user profile may include a user identity and other information related to the user. The user profile information may be assigned or provided by a service provider, provided by the user, and/or obtained from the user or service provider by some other entity or third party. In one embodiment, the user profile information also identifies one or more communications devices associated with the same user, among other user specific information. The device profile information includes a corresponding communications address for each device associated with the user. The device profile may also include other information about each device, for example, the device type (e.g., UE, STB/DVR . . . ), and the content capability of each device, among other device specific information.

In FIG. 1, the user and device profile management entity 130 is illustrated as a single entity, but more generally the profile information may be distributed among a number of entities. In FIG. 1, for example, the services of the ISP 114 and the content provider 118 are provided by a single operator 132, for example, by a Multiple System Operator (MSO). Exemplary service operators include broadband cable and DSL providers that provide digital content, voice and/or Internet service, among others. In embodiments where a single operator provides more than one type of service, it is likely, though not necessary, that the provider possesses user profile and associated device profile information. In FIG. 1, the cellular service is provided by a different operator, and thus the cellular service provider may not have device profile information for services provided by one or more other operators, for example, service providers 114 and 118 in FIG. 1. In some embodiments, the user and device profile information may also be aggregated and managed by third parties unrelated to the service providers. The profile information may thus be available from the service providers and/or from third parties, for example, on permission from the user. Alternatively, the user may provide user and corresponding device profile information to third parties or to a communication campaign manager, as discussed further below.

According to one aspect of the disclosure, a communication campaign management entity manages a communication campaign directed toward a particular user via a plurality of communication devices or media consumption devices associated with the user. In one embodiment, the communication campaign is a promotional campaign, for example, an advertising campaign or a media distribution campaign. In another embodiment, the campaign is a public service announcement campaign, for example, a public notice or emergency broadcast communication. In other embodiments, the campaign relates to some other purpose. In at least some communication campaigns, the communications transmitted to the various communication devices associate with the common user include media or content, for example, audio, video or other multimedia content, that may be presented to the user at a user interface of the communication device.

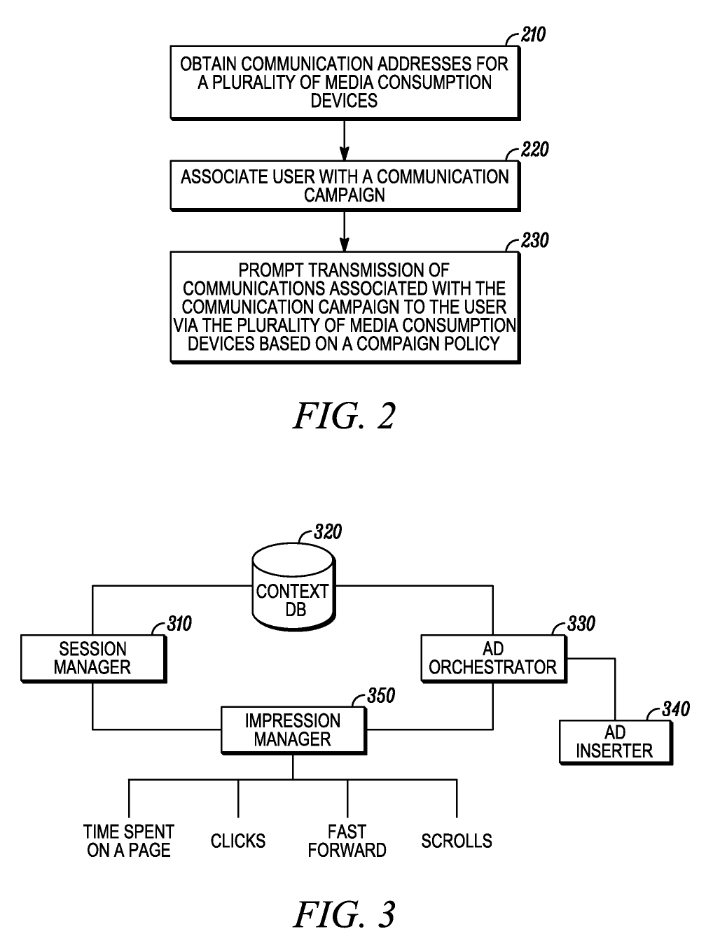

In FIG. 2, at 210, the communication campaign manager obtains communication addresses for each of the plurality of at least two media consumption devices associated with a common user. The campaign management entity will also have access to user profile information and to device profile information for multiple devices associated with the same user. In FIG. 1, the campaign management entity 140 obtains this information from a user and device profile management entity 130. More generally, however, the user and device profile information may be obtained from a variety of other sources, as discussed and suggested above.

In FIG. 2, at 220, the campaign management entity associates a user with a communication campaign. The association of the communication campaign with the user is based on one or more session profiles of the user. The session profile may be behavior or context based. Behavior may be passive or active. Examples of active behavior include the purchase of product, the browsing, selection or downloading of content or media, inputting of key terms or search queries, viewing of promotions, among other actions performed by and accountable to the user. The context may be location or proximity based, or based on a historical location or proximity information. Location and proximity may be determined by location technology integrated in the communication devices or location technology within the network, or based on a known location of the device, for example, an STB location, which may be part of the user profile.

FIG. 3 illustrates an exemplary campaign management architecture comprising a session manager 310. The session manager resides on one or more communication devices associated with a common user. The session manager recognizes the initiation of a relationship, or session, between the user and some other item, for example, a brand. In this implementation, the session or relationship is based on a behavioral or contextual profile of the user, as discussed above. In one embodiment, a session ID is created on the device on which the session is initiated, and then the session ID is shared with other devices association with the common user. The session manager on the device that initiated the session may also start and end a session. The session manager also records session related activities, for example, cross-device interaction pertaining to the session ID. In some embodiments, the session manager may also provide feedback to an impression manager or to the context database as discussed below. Thus the communication campaign, for example, a promotion, may be associated with the user based on the session, which is ultimately based on the user behavioral or contextual profile.

In FIG. 2, at 230, the transmission of communications to the common user via the plurality of media consumption devices is prompted based on a campaign policy. In one embodiment, the campaign policy controls the timing of the communications to the various communication devices, for example, to maximize the value of a promotion. For instance, if is known that consumers generally select a plumber within two days of making their first “request for bid” call, or they select a dinner venue within 30 minutes of beginning to search, then those time intervals (2 days, 30 minutes) may be used to define a duration of the campaign. The end of a productive interval can also be auto-detected, for example, by using location information to detect user entry into a dining venue. In some instances, it is desirable for the campaign manager to terminate a campaign when the productive interval has expired. In other embodiments, the campaign may assume a low activity or dormant phase until another productive interval arises.

In one implementation, the campaign policy controls diversity of communications about a particular topic. The policy may be designed to provide exposure to a product or product category, for example, to new products or to particular industries or trade groups, like milk, or trade unions. The recognition of a product category, e.g., pomegranate juice, could be promoted by a “brand vs. brand” campaign across multiple devices associated with the same user, wherein the user sees a juice ad for competitor A on a mobile station and competitor B on a PC.

In another implementation, the campaign policy controls a frequency with which communications are transmitted to the user via the media consumption devices associated with the user. For example, the policy may control the frequency with which the communications are transmitted to each of the media consumption devices. The campaign policy could also broadcast a promotion during a particularly time slot across devices and media channels to ensure a user's attention for a specific time interval. In other implementations, the policy may be to increases a rate, or frequency, with which communications are transmitted as the occurrence of an event, for example, a new product release date or a due date, approaches. In other implementations, the policy may be to minimize excessive repetitions or to ensure that user does not see the same promotion within a specified interval of having been first exposed to it. This may be implemented using a built-in “timeout” that is enforced across all devices associated with the user.

In another embodiment, the communications comprise different episodes, wherein the policy controls which episode of the communication is transmitted to which of the media consumption devices. In a more particular example, the communication is a sequence of related episodes, and the campaign policy controls which episode of the communication is transmitted to which of the media consumption devices in order to present the episodes to the user in some predefined order. For example, the order of transmission could be controlled so that the user is not exposed to any episode more than one or two occurrences. Alternatively, the order of transmission could be controlled so that the user sees a continuing storyline across viewed episodes. The latter policies may be implemented by obtaining user feedback indicative of episodes to which the user has been exposed.

In FIG. 3, a context (lifecycle) database 320 provides static and dynamic information on the context of a particular campaign communication, for example, a promotional advertisement, and is used by both the session manager and an orchestrator to drive a user experience. The context database provides the various context parameters that need to be evaluated in order to initiate, manage and terminate a communication campaign for the user across the plurality of communication devices associated with the user. Static parameters identify context information that should be evaluated infrequently because of their slow-varying tendencies. These may include domain specific constraints for a specific genre, for example, time or event delimiters to initiate and terminate a campaign. Dynamic parameters indicate context that needs to be evaluated more frequently and may include the keyword or content association that a brand desires, that is shared across devices. The session manager 310 uses the context database to identify parameters that influence the initiation or termination of a specific campaign. For example, it can identify that a campaign is associated with a specific location—and can subsequently trigger the initiation of the campaign for a given user upon determining that the user is currently at the specified location. The orchestrator 330 uses the context database to identify appropriate content to be transmitted to the plurality of devices given the currently reported context from the plurality of devices for that user.

In FIG. 1, the campaign manager 140 selects a communication for each media consumption device based upon device profile information. The communication selected for each device is consistent with the communication campaign associated with the user and the selected communications are transmitted to the corresponding media consumption devices based on the campaign policy. In FIG. 3, this function is performed by an orchestrator 330 having access to an inventory of promotional information, media, and/or other information, based upon the communication campaign. In one implementation, a communication platform provider provides device specific media to the campaign manager for transmission to the devices. The platform provides media formats and types, for example, audio and/or videos, suitable for presentation on user interfaces of the various communication devices, wherein the media is consistent with the communication campaign associated with the user.

FIG. 3, a communication inserter 340 inserts the selected communication in communications streams or pipelines associated with each of the corresponding communication devices. The inserter has knowledge of the modalities and capabilities associated with the plurality of devices involved in the current campaign session, and is responsible for directing the selected content to the right content pipeline (media channel or rendering application) on these devices. For example, the inserter is aware of the existence of a desktop PC with a visual widget platform, a mobile phone with an idle screen display, a set-top Box with DVR functionality and a TV with Picture-in-Picture capability—and knows how to insert content into these various channels for user consumption. As a result, for a multi-modal campaign, the inserter may send text-based content to visual widgets while pushing richer media content to the STB. Further, the inserter could understand different interleavings for media rendering, for example, it can insert the content into a passive awareness display (interstitial consumption) or can embed the content into the currently viewed media (integrated consumption).

According to another aspect of the disclosure, after directing a communication campaign toward a user associated with a plurality of media consumption devices, the campaign manager tracks performance metrics of the communication campaign based upon interactive information obtained from the plurality of media consumption devices associated with the common user. For example, the performance metrics may be tracked based upon user feedback or interaction, or other user actions. Such actions may be either explicit or implicit. Exemplary explicit actions include browsing or selecting content, scrolling or fast forwarding through content. Implicit actions could be based on location or contextual feedback. Also, the reporting may be periodic or on-demand, for example, in response to a request of the impression manager. In one embodiment, the performance of the communication campaign may be tracked as it relates to one or more of the plurality of media consumption devices based upon the interactive information obtained from at least one other media consumption device.

FIG. 3 illustrates an impression manager 350 for carrying out these functions. The Impression Manager has device-specific and device-independent capability. The device-specific function includes collecting device-appropriate interaction telemetry (clicks, fast forwards, scrolls, time of views, interruptions from phone calls, among others) from devices with varying affordances. The interaction telemetry is reported to the device-independent component, which then homogenizes these interaction streams into a device-independent engagement metric indicative of the user's impression of the communication campaign. The impression manager may also communicate impression data to the session manager 310 for logging and session lifecycle management purposes.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method for managing a communication campaign among a plurality of media consumption devices associated with a common user, the method comprising:
obtaining communication addresses for each of the plurality of media consumption devices associated with the common user;
associating the common user with a communication campaign;
prompting transmission of communications to the common user via the plurality of media consumption devices based on a campaign policy.

2. The method of claim 1, associating the common user with the communication campaign based on a behavioral profile of the common user.

3. The method of claim 1, associating the common user with the communication campaign based on a contextual profile of the common user.

4. The method of claim 1, prompting the transmission of communications to the common user based on a campaign policy that controls diversity of communications about a particular topic.

5. The method of claim 1, prompting the transmission of communications based on a campaign policy that controls a frequency with which the communications are transmitted.

6. The method of claim 1, prompting the transmission of communications based on a campaign policy that controls a frequency with which the communications are transmitted to each of the media consumption devices associated with the common user.

7. The method of claim 1, prompting the transmission of communications based on a campaign policy that increases a frequency with which the communications are transmitted as an event occurrence approaches.

8. The method of claim 1,
the communications comprise different episodes,
prompting the transmission of the communications based on a campaign policy that controls which episode of the communication is transmitted to which of the media consumption devices.

9. The method of claim 1,
the communication comprises a sequence of episodes,
prompting the transmission of the communications based on a campaign policy prompts transmission of the episodes of the sequence in a predetermined order based on prior communications with the common user on the plurality of media consumption devices.

10. The method of claim 1,
obtaining profile information for each of the media consumption devices,
selecting a communication, consistent with the communication campaign, for each of the media consumption devices based upon the profile information,
prompting transmission of the communications includes prompting the transmission of the selected communications to each the corresponding media consumption devices based on the campaign policy.

11. The method of claim 1, prompting transmission of communications to the media consumption devices includes prompting transmission of media to the media consumption devices, wherein the media may be presented at a user interface of the media consumption devices.

12. The method claim 11, tracking performance metrics of the communication campaign associated with the common user.

13. The method claim 11, tracking performance metrics based upon interaction information provided media consumption devices.

14. The method claim 11, tracking performance of the communication campaign as it relates to one of the plurality of media consumption devices based upon the interactive information obtained from at least one other media consumption devices associated with the common user.

15. A method for managing a communication campaign among a plurality of media consumption devices, the method comprising:
directing a communication campaign toward a user associated with a plurality of media consumption devices;
tracking performance metrics of the communication campaign based upon interactive information obtained from the plurality of media consumption devices associated with the common user.

16. The method claim 15, directing the communication campaign toward the user by prompting transmission of communications to the plurality of media consumption devices based upon a campaign policy.

17. The method claim 15, tracking performance of the communication campaign as it relates to one of the plurality of media consumption devices based upon the interactive information obtained from at least one other media consumption devices associated with the common user.
